(19) United States
(12) Patent Application Publication
(10) Pub. No.: US 2008/0201388 A1
(43) Pub. Date: Aug. 21, 2008

(54) System and method for equipment tracking and preventative maintenance scheduling and verification

(76) Inventors: Luke Wood, Highlands Ranch, CO (US); Michael D. Parmett, Lakeville, MN (US); Greg Slater, Highlands Ranch, CO (US)

Correspondence Address: C. JAMES BUSHMAN, 5718 WESTHEIMER, SUITE 1800, HOUSTON, TX, 77057, US

(21) Appl. No.: 11/708,429

(22) Filed: Feb. 20, 2007

(51) Int. Cl. G06F 17/30

(52) U.S. Cl. 707/203; 707/E17.01

(57) ABSTRACT

An asset tracking and maintenance scheduling and verification system for coordinating preventative or periodic maintenance activities for a collection of assets. A system server is responsible for maintenance of an asset database including a database record for each asset identifying tracking and maintenance information for the asset. The system server generates task lists for assets based at least in part upon data stored in the database. One or more remote handheld devices are in selective communication with he system server to receive the task lists, whereupon a user in possession of a handheld device is directed to perform a series of tasks on one or more assets. In the course of performing such tasks, a user inputs task-related information that is subsequently uploaded to the system server and incorporated into the database, such that subsequent task lists generated by the system server will reflect previous performance of tasks.

### FIELD OF THE INVENTION

The present invention relates to the field of asset tracking and maintenance, and more particularly relates to a system and method for scheduling and verification of equipment maintenance activities.

### BACKGROUND OF THE INVENTION

There are a variety of commercial/industrial settings involving the use of often complex and costly pieces of equipment, sometimes referred to generically as “assets,” with individual pieces of equipment or components thereof being used, stored, maintained, and/or moved between distributed locations throughout a worksite or extended operational setting. It is usually considered desirable to have procedures in place to ensure that the whereabouts of such assets at any given time are known, and, more importantly, that proper regular or preventative maintenance activities are performed to ensure that equipment is maintained in good working order.

A prime example of the foregoing, although by no means the only such example, is the suite of equipment (assets) associated with and used in connection with operation of oil and gas drilling rigs and the like. (As used herein, the term “oil and gas rig” shall be construed broadly, to include, for example, conventional drilling platforms, coiled tubing rigs, top drive rigs, rotary table rigs, workover rigs and the like. Even so construed, the present invention is by no means limited in its application to this limited class of applications, as will be appreciated by persons of ordinary skill in the art having the benefit of this disclosure.) The environment of a drilling rig is often harsh and the equipment used for typical drilling operations can be subjected to rigorous use under very demanding conditions. In situations such as this, the ongoing tracking of equipment to ensure its availability whenever and wherever it may be needed is critical, and performance of regular preventative maintenance activities is very important to ensure the safe and operable condition of the equipment.

Drilling operations usually involve the participation of a variety of workers, each having specialized skills and training appropriate for the job(s) for which they are responsible. It is often not practical to dedicate a single person or group of people to be responsible for tracking the whereabouts and condition of individual pieces of equipment utilized during a prolonged drilling operation, or to be responsible for ensuring that each piece of equipment is regularly maintained and serviced in such a manner as to ensure that the equipment remains operational and safe.

Moreover, it is often not possible or practical to call upon highly skilled individuals to perform routine tracking and maintenance operations. On the other hand, it is important to ensure that persons having less technical training or experience are capable of performing such operations reliably and properly. Not only do companies wish to track and maintain asset management information for their own purposes, but in some cases there may also be regulatory requirements to do so. The Sarbanes-Oxley Act of 2002 (Pub. L. No. 107-204, 116 Stat. 745, also known as the Public Company Accounting Reform and Investor Protection Act of 2002, is one example of a regulation imposing specific legal obligations for public companies to track and maintain assets. Such legal requirements are likely in the future to extend to other countries, and perhaps even to privately-held concerns.

### SUMMARY OF THE INVENTION

In view of the foregoing, the present invention is directed to a system and method for proactive, on-command asset tracking and preventative maintenance scheduling and verification.

In one embodiment, the invention comprises a system designed to ensure that equipment tracking and preventative maintenance activities for surface-based equipment are coordinated and executed correctly. Adherence to schedules and maintenance protocols imposed by the system is ensured by proactively tasking the user to be physically present at each location at which a task is to be performed, and by affirmatively verifying the completion of each specified task. Protocols are defined by templates created by a user and will include provisions for ensuring attention to asset-specific attributes.

The operator of a system in accordance with the invention can generate a template including attributes unique to each asset and the tracking and maintenance tasks that are to be performed for each asset. This gives the system in accordance with the invention considerable flexibility and enables it to be implemented effectively in a wide variety of environments.

In another embodiment, the system in accordance with the present invention is a task management system that generates a work order for personnel based upon an assessment of what jobs need to be performed at any given time. These work orders are generated automatically by the system (based upon the template predefined by the operator) and take into account the individual attributes of each asset as well as the requirements for the equipment; these being based on historical and current data associated with that asset. The ongoing execution by users of these work orders is then tracked and managed.

In accordance with another aspect of the invention, means are provided for uniquely identifying each individual asset to be tracked and maintained. By way of example but not limitation, it is contemplated that existing radio-frequency identification (RFID) technologies can be employed, such as by affixing an RFID tag to each asset.

In accordance with another aspect of the invention, the system eliminates the ability for a user to falsify or forge results. This is accomplished in part by requiring “proof of presence” to be established for each specified task before it is considered “complete.” The limited range of a typical RFID tag advantageously accomplishes this proof-of-presence function, since the user must bring the reader (preferably incorporated into a handheld unit carried by the user) into sufficient proximity to each given asset that each asset's unique identifier can be retrieved and recorded in the handheld unit. Checks and readings provided by users in the course of completing tasks are validated against expected results in real time. Any deviations from expected results are highlighted and brought to the immediate attention of the user, as well as to control or supervisory personnel.

Another feature eliminating the opportunity to forge or falsify results is that the unique identifier for each asset may not be directly readable by humans, thus preventing entry of falsified entries. The RFID tag implementation can be particularly effective in this regard, inasmuch as an RFID tag typically cannot be interrogated without compatible hardware.

In accordance with still another advantageous aspect of the invention, the system is scalable and flexible, such that it can be configured to suit individual requirements of differing types. Existing paper-based maintenance programs can be automated to ensure compliance, and entirely new tracking and maintenance protocols can be created. Non-traditional assets of virtually any type can be included in the inventive process for tasking and management purposes. Notably, this flexibility includes the ability to create task lists relative to non-physical assets/elements. For example, a system in accordance with the invention can track and document the occurrence of safety meetings and the like at which each attendee's attendance can be tracked by interrogation of an ID badge or the like carried by individuals.

Notably, task lists can be created, edited, and activated centrally and locally by rig managers, i.e., at a central server, as required. In a preferred embodiment, provisions are made to ensure that users are specifically limited in their ability to edit transactional data. This ensures that a fully auditable history is maintained; any changes to a protocol or to revisions of entries are able to be tagged with date, time, and user information resulting in complete accountability at all levels of operation.

### BRIEF DESCRIPTION OF THE DRAWINGS

The foregoing and other features and aspects of the present invention will be best appreciated by reference to a detailed description of some specific embodiments of the invention, when read in conjunction with the accompanying drawings, wherein:

FIG. 1 is a diagram illustrating the main components of an asset tracking and maintenance scheduling and verification system in accordance with one embodiment of the invention;

FIG. 2 is a flow diagram illustrating operation of the system of the present invention; and

FIG. 3 is a functional block diagram of a system in accordance with the present invention implemented to support the asset tracking and maintenance processes for a plurality of clients.

### DETAILED DESCRIPTION OF A SPECIFIC EMBODIMENT OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such a development effort might be complex and time-consuming, but would nevertheless be a routine undertaking for those of ordinary skill in the relevant fields.

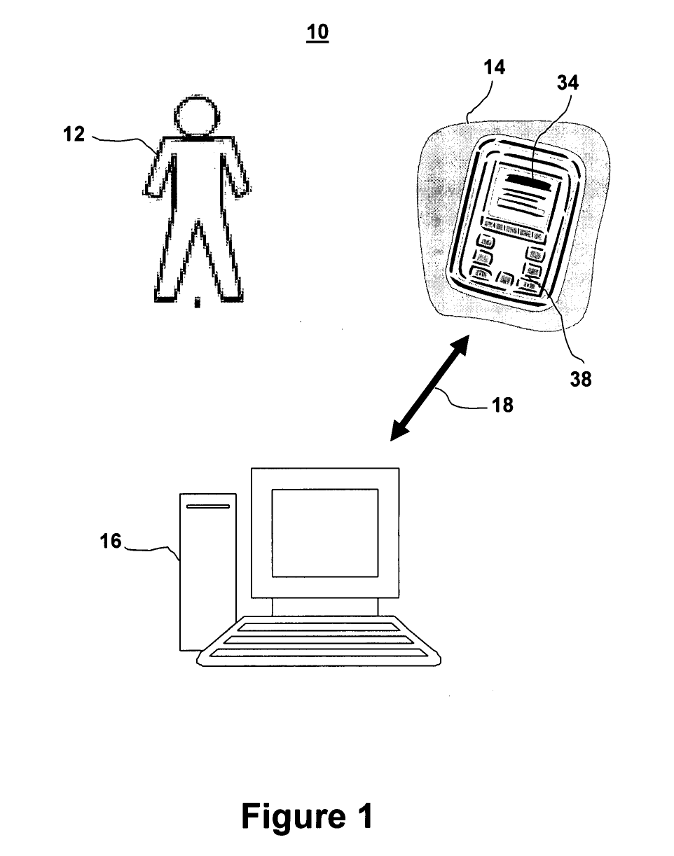

FIG. 1 depicts the main components of an asset tracking and maintenance scheduling and verification system 10 in accordance with a presently preferred embodiment of the invention. As shown in FIG. 1, system 10 relies upon the involvement of a user 12. In accordance with one significant aspect of the invention, and as will become further apparent in the present disclosure, system 10 is preferably implemented in such a way that very little is demanded of user 12 other than performing the tracking and maintenance tasks specified by the system 10. Thus, system 10 is ideally suited for applications where persons of varying degrees of technical expertise and training may be called upon to perform the specified tasks. For example, for a system 10 implemented for operation on an oil and gas rig, system 10 can be advantageously used by “roughnecks” or “tool pushers” just as effectively as it could be used by highly qualified engineers.

With continued reference to FIG. 1, system 10 further comprises a handheld computing module or handheld computing device or terminal (often referred to as a handheld terminal or “HHT”) 14 intended to be carried by user 12 in the course of operation of system 10. Those of ordinary skill in the art will be aware of a wide variety of general-purpose handheld computers that are commercially available from numerous sources and that are suitably capable of functioning as the HHTs contemplated by the present invention and being programmed to operate in accordance with the presently disclosed embodiment of the invention. In a preferred implementation, the HHTs 14 are “intrinsically safe,” meaning that they comply with the variously applicable requirements imposed upon equipment allowed to be utilized in hazardous environments, as would be appreciated by those of ordinary skill. Commercial examples of such HHTs suitable for the purposes of the present invention are widely known.

Further, system 10 comprises a system server computer 16, which persons of ordinary skill in the art will recognize as perhaps being of the widely known and commercially-available “server” class of computers. In the presently preferred embodiment, server 16 operates under control of the Microsoft® MS2003® operating system, commercially-available from Microsoft Corp., Redmond, Wash. Those of ordinary skill in the art will recognize that this operating system is a very broadly adopted industry standard.

In the presently disclosed embodiment of the invention, server 16 may be located at some central location, which will be preferably and unlikely to be physically located be on the premises at which the users of system 10 is conduct their activities, i.e., not where the tracking and maintenance operations are actually performed. For this reason, system 10 further comprises a communications link 18 between server 16 and handheld unit 14, and this communications link can take one or more of a wide variety of different forms, including, without limitation, local-area or wide-area wireless connectivity, Internet connectivity, satellite connectivity, combinations of these connectivity modalities, and so on, depending upon the environment in which system 10 is intended to be operated. The communications link 18 may be adaptable to permit handheld units 14 to dynamically adapt to the environment and utilize one of a plurality of different communications modalities (e.g., satellite, wireless, hard-wired, etc.) depending upon what is available.

In one embodiment, communications link 18 includes a transceiver such as a satellite-based modem for facilitating communication from the handheld unit 14 to central server 16. In such an implementation, the handheld unit 14 connects to the modem and a secure Internet connection is made by some means with the server 16. This ensures that any handheld unit 14 with adequate Internet connectivity can communicate with server 16. Once a connection is made, data can be transferred between handheld unit 14 and server 16.

Further in accordance with the disclosed embodiment, once the server 16 has received data from the handheld unit 14, this information can be subsequently relayed to other remote sites, as well as being stored and processed directly by server 16.

As previously mentioned, system 10 requires each asset or piece of equipment to be tracked and/or maintained, viewed, managed, or otherwise handled to have its own unique identifier. In the presently preferred embodiment, this is accomplished by affixing a radio-frequency identification (RFID) tag to each asset. Those of ordinary skill in the art will understand that RFID tags are adapted to be programmed for precisely this purpose. RFID tags can be interrogated by a compatible reader to identify each asset. In the presently preferred embodiment, the RFID reading functionality is established within handheld unit 14.

Of course, RFID tagging is not the only way that assets may be uniquely identified, and those of ordinary skill in the art will appreciate that the present invention is by no means limited to the use of RFID technology. As but one alternative example, each asset may be provided with a unique bar code, and each bar code can be read by an appropriate bar code reader, likewise also associated with and/or within handheld unit 14. In accordance with a significant aspect of the invention, the unique identification of assets is a purely passive function; that is, the means for unique identification need not be modified during operation of the system 10. All equipment-specific information is stored in database(s) maintained in handheld unit 14 and/or on server 16.

As previously noted, the use of RFID tags as unique identifiers has the additional benefit of performing a proof-of-presence function for system 10. That is, a user 12 cannot obtain the asset identifying information unless he or she is sufficiently near to the asset to be capable of interrogating the RFID tag. As previously noted, identifiers such as RFID tags are not human-readable, thereby eliminating an entire category of user fraud.

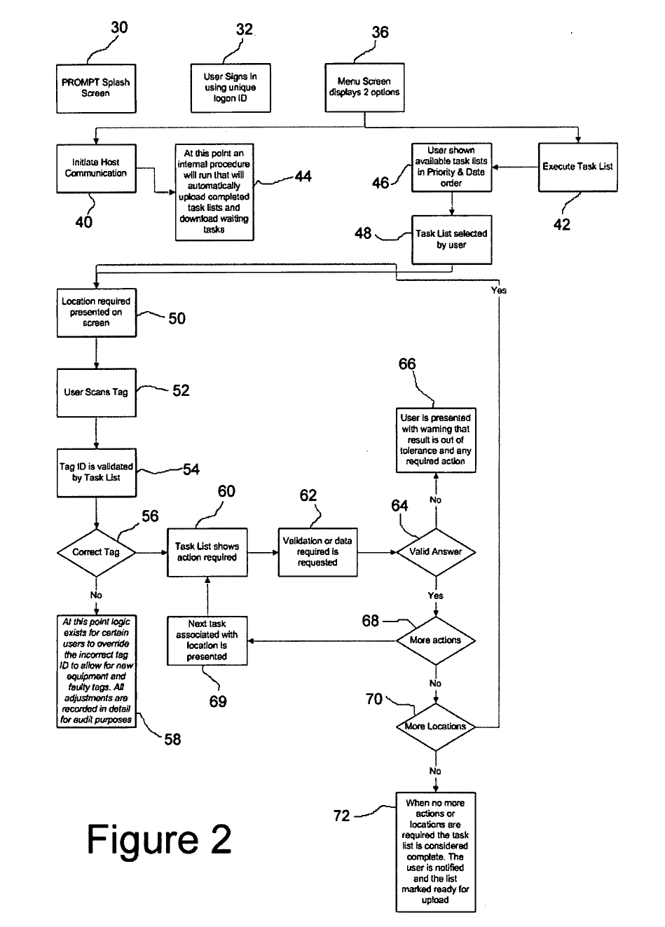

Turning to FIG. 2, there is shown a flow diagram specifying the operation of system 10 in accordance with the presently disclosed embodiment. As previously noted, system 10 involves participation of a user 12, a handheld unit 14, and a central server 16. The flow diagram of FIG. 2 details the interaction of all of these components.

With regard to the programming of handheld unit 14 and server 16, it is believed that those of ordinary skill in the art having the benefit of the present disclosure will readily appreciate how the functionality as depicted in FIG. 2 can be achieved without any degree of undue experimentation. Although it has be noted that the presently preferred embodiment of the invention utilizes a server 16 executing the MS2003 operating system, the selection of this particular platform is not believed to be essential for the purposes of advantageously practicing the present invention.

Furthermore, as will be described in greater detail below, the system 10 preferably involves the definition, creation, and maintenance of a SQL (structured query language) database, with records corresponding to the inventory of equipment/assets that are to be subjected to the processes of the present invention. On the other hand, while the presently preferred embodiment involves a SQL database, it is believed once again that this is not necessarily essential to the practice of the invention. Likewise, the presently preferred embodiment of the invention makes use of the well-known and commercially-available HighJump Software toolkit for its implementation, although once again the selection of this particular solution is by no means essential for the purposes of implementing and enjoying the full benefit of the present invention.

To the extent that the invention is implemented using the MS2003 operating system for server 16, the HighJump software toolkit, and a SQL database established to record the information about the assets/equipment in question, it is known to the inventors that an innumerable number and combination of software applications, tools, programming languages and constructs, and operating platforms are known and available to those of ordinary skill in the art to implement a system capable of performing the functions described herein. The very low-level, specific implementation details of the presently disclosed embodiment is not set forth herein, as it is believed that this would only obscure the disclosure of the fundamental features of the invention.

With reference to FIG. 2, those of ordinary skill in the art will understand that the invention is experienced by a user 12 primarily through the handheld unit 14 which serves as the principal user interface. That being understood, a first feature of the invention occurs upon activation of handheld unit 14, at which time an identifying “splash screen” is displayed, informing the user that an instantiation of the system is beginning. This is represented by block 30 in FIG. 2.

After an appropriate period of time, the handheld unit 14 will present the user 12 with an interactive screen calling for entry of a unique user identifier and, in most preferred embodiments, a security password, as represented by block 32 in FIG. 2. In a preferred embodiment, each user 12 will be provided with an identification card or badge which itself includes means such as an RFID tag for uniquely identifying the users. Again, this reduces the opportunity for users to fabricate results, without the user taking any affirmative action other than carrying the identifying badge or the like on his/her person during the course of operation.

Assuming that the challenge of username and password is met by the user 12, the system 10 will provide for the display of a menu screen on a display area 34 of handheld unit 14. This presentation of the top-level user selection menu is represented by block 36 in FIG. 2.

The menu presented at block 36 allows user 12 to select one of two options (in the presently disclosed embodiment), which options can be selected via the user interface 38 of unit 14. User interface 38 may take a variety of forms, including, by way of example but not limitation, dedicated or “soft” pushbuttons on the face of unit 14, a touch-screen activated either by hand or using a stylus, or any of the wide variety of user input mechanisms known and widely utilized in many applications in the art.

The two options presented to user 12 at block 36 are: (1) Initiate Host Communication, as represented by block 40 in FIG. 2; or (2) Execute Task List, as represented by block 42.

In the case of initiation of host communication at block 40, this step involves activation of communications link 18 (see FIG. 1) to allow handheld unit 14 to exchange data and instructions with server 16. One of the primary actions to take place upon activation of communications link 18 is the uploading (i.e., from server 16 to handheld unit 14) of one or more pending task lists, and, to the extent applicable, the downloading, from handheld unit 14 to server 16, of data corresponding to task lists already performed by the user of handheld unit 14. All of this is represented by block 44 in FIG. 2.

On the other hand, if at block 36 the user 12 selects the option corresponding to block 42 in FIG. 2, one or more uncompleted, pending task lists are displayed (on display 24), enabling user 12 to select a particular task list that the user 12 is prepared to execute. This is represented by block 46 in FIG. 2. At this point, user 12 selects a particular task list, using the user interface(s) provided on device 14. This is represented by block 48 in FIG. 2.

Although the exact format and content of a task list is not disclosed herein in minute detail, it is sufficient to note that the task list will interactively provide the information necessary for user 12 to perform the specified tasks, beginning, as represented at block 50 in FIG. 2, with the identification of a location at which a particular task is to be carried out. Although it has been previously noted that the present invention is not limited to application in oil and gas drilling rigs and the like, if indeed implemented for such use, system 10 may at block 50 identify a particular piece of equipment or a particular location on the rig that is necessary to be physically visited by user 12.

Upon arrival at an appropriate location, user 12 will commence the tracking/maintenance process by first interrogating the subject of the particular phase of the process, i.e., a particular piece of equipment, a particular component of such equipment, or other location. The interrogation process, represented by block 52 in FIG. 2, may involve, in one embodiment, the reading of an RFID tag affixed to the equipment in question, the scanning of a bar code, or some other method for uniquely identifying the subject in question.

As previously noted, the inherent qualities of RFID tags are such that the user 12 must be within a certain proximity of the interrogated equipment, owing to the limited range of RFID transmissions. As such, the RFID option for the present invention advantageously accomplishes the task of verifying the user's actual presence at a particular location, since no successful interrogation can take place otherwise. Likewise, for example, if a bar code is utilized as the means for uniquely identifying a subject asset, this bar code cannot be scanned unless user 12 is physically present at the particular location, thereby similarly providing a “proof-of-presence” function for system 10. In the case of barcode utilization the system may incorporate a check digit inserted automatically by the HHT to ensure that the unique identifier is not manually entered.

Upon interrogation and identification of the subject asset in block 52, system 10 responds by verifying the accuracy and authenticity of the asset, as shown at block 54. This step may be performed by reference to a local copy of an asset database (e.g., a SQL database) that is stored internally to handheld unit 14, or by reference to a database maintained only on server 16, in the case where the reliability and integrity of communications link 18 can be ensured throughout the operational process. More often, reference will be made to a locally stored database, which will be capable of validating the accuracy of the user's location.

The asset database will further preferably provide a means for system 10 to ensure that an identifier of a particular asset is one that is recognized by the system 10 by virtue of prior initialization and operation of system 10. Thus, for example, a user may interrogate say, a pump, having an RFID tag affixed thereto, while the data maintained in handheld unit 14 and/or central server 16 will contain validating information ensuring that the proper asset is being examined. This is represented by decision block 56 in FIG. 2.

In the event that the interrogated asset does not prove to be that which the system 10 expects to be found at a particular location, the process moves to block 58, which represents a step of allowing user 12 to override the system based upon real-world events that have not previously been made known to system 10, for example. The process at block 58 may further provide for user 12 to identify new assets not previously known to system 10, or to overcome situations in which a known asset has a faulty identification mechanism (e.g., a corrupted RFID device or an obscured bar code).

In accordance with an important aspect of the invention, the operation represented by block 58 preferably further includes recordation of information necessary to explain exactly what has transpired at a location, whether it be faulty identification of an expected asset, introduction of a new asset, or other situations in which user 12 is permitted to override system 10 to perform the overall tracking/inspection/maintenance operation protocol.

It is at this point (block 58) that system 10 is capable of providing vital and dynamic track and trace functionality. For example, if a user 12 is asked to scan a particular type of asset and the scan returns an unexpected ID corresponding to the same or similar type of asset to that expected, the system may allow the user 12 to continue and record on the host system the revised location for that asset.

On the other hand, it will more commonly be the case at block 56 in FIG. 2 that the correct asset is identified, in which case process flow proceeds to block 60, in which system 10 causes handheld unit 14 to present to user 12 instructions to perform a specified task. Specified tasks can include virtually any action, ranging from mere confirmation that a given asset is present at its proper location, to complex maintenance operations and the like. Notably, the particular instructions are dynamically configurable by a particular user. This ensures that the system 10 can be configured to suit a broad spectrum of assets with an essentially unlimited level of detail depending upon client requirements/desires.

In many cases, the action to be performed will involve acquisition or entry by user 12 of data representing successful completion of a particular action, or confirmation of the status of an asset at a particular time, and so on. In these cases, user 12 is prompted to enter corresponding values using the user interface 38. Thereafter, these values can be processed by system 10 to determine whether such input falls within acceptable or expected parameters. As a highly primitive example, user 12 may utilize handheld unit 14 to make an entry indicating a pressure value at a particular location. System 10 may then determine whether or not the inputted value falls within an acceptable range. This validation step is represented by block 62 in FIG. 2.

At decision block 64 in FIG. 2, system 10 determines whether established data provided by user 12 is or is not deemed “valid.” If not, as represented by block 66 in FIG. 2, handheld unit 14 presents the user 12 with a warning that the results of the inspection or maintenance operation do not fall within acceptable limits; this is represented by block 66 in FIG. 2. The user 12 can thereafter take appropriate measures, for example, to bring the asset into compliance.

For example, at this point system 10 can initiate a process instructing the user 12 to seek supervisory authority in order to proceed beyond a given specified task. As a simple example, should a user 12 record a low fluid level for a piece of equipment, system 10 can provide user 12 with specific instructions to remedy the low-level condition. Further, the system 10 may require a user 12 to confirm supervisory acknowledgement of the remedial action, for example, by scanning a manager's own identification tag.

If in decision block 64 valid data is identified, process flow in accordance with the presently disclosed embodiment proceeds to block 68, which corresponds to a decision made by system 10 whether all tasks at the present location have been accomplished, or whether more actions are to be taken at the current location. In the case that additional tasks are to be performed at the current location, the process transfers to block 69, at which time an additional task associated with the current location and/or asset is presented to user 12.

On the other hand, if the task list has been completed or whether one or more additional assets must be visited in order to complete the specified list of tasks, as represented by block 70, the user is instructed to relocate to another location, at which time process flow will re-commence at block 52, wherein the user verifies that the proper location has been located.

Eventually, a particular task list will be fully completed, meaning that no further actions are to be taken in order to fulfill the list of necessary operations. This is represented by block 72 in FIG. 2. In this case, the task list is marked as “completed,” such that upon reestablishing communication between handheld unit 14 and server 16 (via link 18), the data acquired during execution of the specified tasks is uploaded to server 16. This information is then used by server 16 in the process of developing future task lists that are presented to a user on a subsequent instantiation of the process.

In accordance with a significant feature of the invention as thus far described, the system 10 is implemented so as to ensure that predetermined inspection/maintenance protocols are observed in a disciplined, verifiable, and documented fashion. The various protocols to be observed are defined in server 16, such that any particular user or combination of successive users can be relied upon to carry out the specified tasks. This renders the system 10 highly adaptable to many different environments and applications.

In one embodiment of the invention, each asset or unique item in a given application will have an asset record maintained in the SQL database (as described above). An asset record preferable provides information including “fixed” information, “static” information, and “dynamic” information. The following Table 1 provides a generalized framework for asset records maintained by system 10 in accordance with the presently disclosed embodiment.

TABLE 1

| | Data Fields | | | |
|---|---|---|---|---|
| Fixed | Description | Purchase date | Original Value | Serial # |
| | Asset Register # | Manufacturer | Date Active | Status |
| | Depreciation Rule | | | |
| Configuration Data | Description of Action | HHT Description of | Frequency Required - | Frequency Required - |
| | Required | Action | Days | Cycles |
| | Expected Pass | Fail Results | HHT Instruction for Fail | RFID Tag # |
| | Result | | Result | |
| | Type of Asset | Type of Check | Cost of Replacement | |
| | | Required | | |
| Dynamic Data | Current Location | Next Check Due | Worksheet Number for | Last Check Complete |
| | | | Next Check | |
| | Last Check | Current Status | Alert | Current Book Value |
| | Worksheet Number | | | |
| | Last Repair Cost | Last Repair Agent | Previous Location | Date Arrived in Current |
| | | | | Location |

“Fixed” data is created when an asset is first entered into system 10, typically via server 16, but possibly during field operation via handheld unit 14. Once entered, “fixed” information cannot be changed or edited and the item can only be made inactive or discarded. This creates a record and provides the core tracking data likely to be used by other inventorying and tracking systems. Those of ordinary skill will appreciate that this data can be shared with other applications as required or desired.

“Configuration” data is configuration level data created by users (12) and updated as necessary. “Configuration” data is not automatically updated by any other process or system, and is used to control how and when different assets become subject to the tracking/maintenance processes of the present invention.

“Dynamic” data is information that is either populated automatically via an external source, e.g., handheld unit 14, or automatically generated internally to system 10.

The asset record maintained by system 10 is, as disclosed herein, highly configurable and allows users in any given implementation of the invention to define specific levels of granularity at which system 10 will operate. Asset records can be created for non-standard assets or locations (e.g., “The Boiler Room”) should an implementer wish to create tasks associated with such assets/locations.

Those of ordinary skill in the art will appreciate that the displays, instructions, and other interactive fields presented by handheld unit 14 are also susceptible to a high degree of configurability, so that users, can, for example, set maintenance standards according to recognized schedules or generic or custom standards relative to a particular asset.

In accordance with a significant aspect of the invention, explicit categorization and recognition of data as being either “Fixed,” “Configurable,” or “Dynamic” ensures that an auditable history is created and that compliance to third party regulations/standards (e.g., insurance, accounting) can be achieved in a verifiable and consistent manner.

The programming of server 16 in the presently disclosed embodiment includes a Task Management module, being the method by which tasks and schedules of tasks are assigned to relevant users 12. Server 16 will create a task list based upon analysis of selected assets and determinations of which asset records require updating. In many cases, it is contemplated that such analysis will focus much on dates. For example, a task worksheet generated on a given date will identify all assets requiring attention on or before that date. This can then be filtered according to any other attribute, such as asset location, or asset type. Automatic generation of task lists is made possible due to the systematic categorization and recording of asset data.

Parameters unique to a particular task to be performed can also be defined at server 16. This can control, for example, the eligibility of a given individual to complete a given task list. This information is also useful to identify expected (or required) completion dates and times. Different tasks or sets of tasks can be assigned to different individual users 12 as desired. For example, weekly safety checks may be performed by one person, while daily mechanical maintenance or checks can be assigned to a different person.

In a preferred embodiment, server 16 maintains task lists in order and issued to appropriate users 12 once communications are established over link 18. The entire task list is preferably downloaded to a specified handheld unit 14 and managed in a “batch” mode. Upon completion of a task list, the list and the various data acquired or entered in the course of completion are uploaded via link 18 to server 16, at which time appropriate updates and adjustments can be made to the database.

Unexpected adjustments to database data (for example, introduction of a new asset, or out-of-range readings from an asset) are highlighted or otherwise brought to the attention of a system manager operating server 16, for further analysis and conformation. System 10 thus is capable of accepting all answers for audit history purposes, but at the same time is adapted to alert relevant personnel to data falling outside of predetermined, configurable parameters.

The following is a specific case study illustrating various advantageous features and aspects of the presently disclosed embodiment of the invention:

On a drilling rig, a coolant pump is set up as an asset (i.e., fixed data). The coolant pump requires daily checks of its fluid level, and weekly checks on its pressure valve (configuration data). The user 12 is instructed to read the coolant level gauge and enter high, normal or low. Normal is the ‘pass’ response (at block 64 in FIG. 2); High or Low are ‘fail’ responses. A fail response will alert the user to take relevant action (configuration data), corresponding to block 66 in FIG. 2. The pump is recorded as being on a particular individual rig (dynamic data)

Task list creation parameters are set by server 16 to create a daily task list for the rig (configuration data). The daily list will require the user 12 to visit and report against all items due a check on that day.

On the first day the user on the rig downloads his or her task order from server 16 to handheld unit 14. User 12 is then directed to check the coolant pump. User 12 goes to the pump, interrogates the unique identifier (e.g., scans an RFID tag) and is instructed to check the coolant level. User 12 then enters the response from a drop down list presented on display 34. The user 12 is not instructed or required to do anything else. Later that week, when the same task list is run, the user 12 is sent to the coolant pump again. User 12 scans the identifier (RFID tag) and is instructed the check the coolant level—a weekly operation. Once this is complete, the user is then instructed to check the pressure valve and presented with a drop-down list of responses. Once complete, the user 12 uploads the information to server 16.

The central server now has possession of date, time and user information for the last checks and the responses given. Server 16 will then show any discrepancies associated with this data. Examples of key areas are an overdue check, ‘fail’ responses or unexpected asset identifiers. Based on this information, a system operator can then take the appropriate actions.

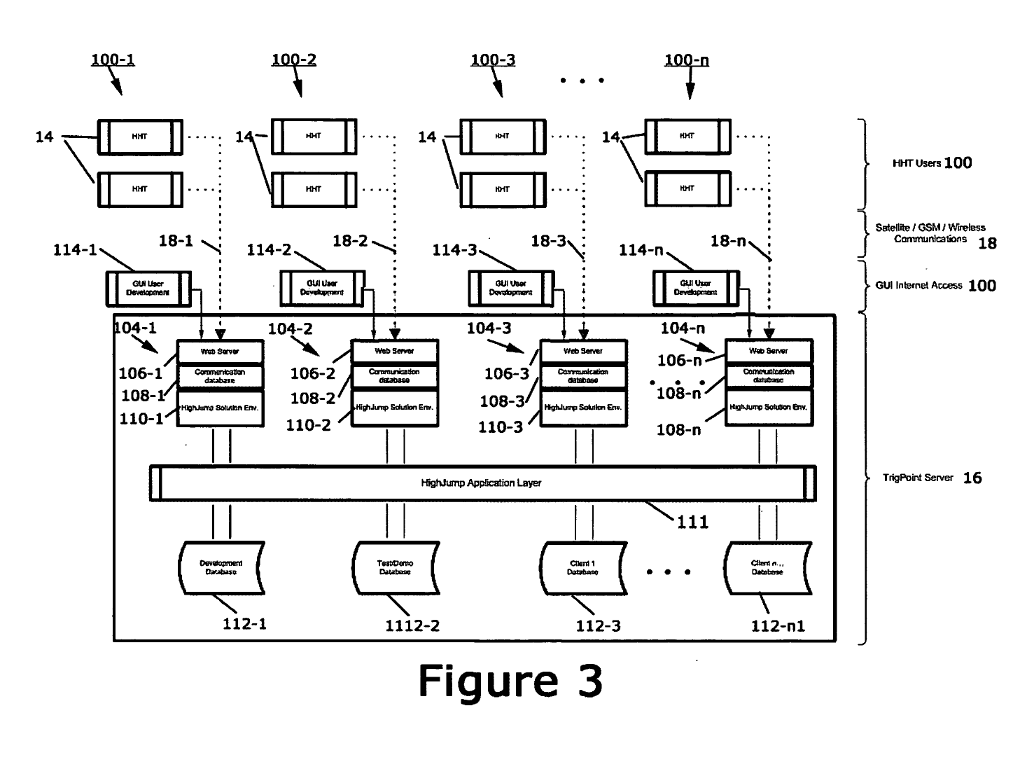

To further illustrate an exemplary embodiment of the invention, FIG. 3 is a functional block diagram showing how an operator of system 10 can support the asset maintenance and tracking operations for a plurality of separate end users. In particular, in the example of FIG. 3, a plurality of system “clients” 100 are supported, with individual clients being identified with reference numerals 100-1, 100-2, 100-3 . . . 100-n.

As depicted in FIG. 3, each client 100 utilizes a plurality of handheld units 14. (Although each client 100 in FIG. 3 is shown to have only two associated handheld units 14, this is symbolic only and it is to be understood that different clients may have differing numbers of handheld units 14 depending on their respective needs.)

Each handheld unit 14 communicates with the system server 16 by means of its own communications link 18, as previously described with reference to FIG. 1. For each client 100, server 16 opens a separate instantiation 104-1, 104-2, 104-3, . . . 104-4 of the system application 111. Each instantiation 104 includes a generic web server 106 serving as the interface to system 16 for each client 100. Further, each instantiation 104 further includes a communications database 108-1, 108-2, 108-3, . . . 108-n, each of which being potentially customizable for the particular client 100 depending, for example, on the particular information maintained by system 10 for each client 100.

Each instantiation 104 further includes a separate executing copy of the system application software 110, which manages the storage and retrieve of client data from a client database 112. In accordance with one aspect of the invention, server 16 preferably maintains a separate database 112 for each client, so as to avoid inadvertent disclosure of one client's data to another. It the task of each separate system environment 110 executing on behalf of each client 100 is responsible for managing the data in the associated client's database 112.

With continued reference to FIG. 3, each client 100 is provided with a user interface 114. User interface 114 is the means by which a client customizes the system for its particular needs, for example, to add and delete assets and other items to be tracked and maintained, to specify tracking and maintenance requirements and schedules for each asset, to specify the content of task lists and to cause such task lists to be created and provided to an individual user by downloading to an individual handheld unit 14 on demand. It is contemplated that some or all of these functions may also be accomplished directly through a handheld unit 14. For example, in the course of performing the tasks on a task list, a user may encounter situations where a particular asset has been added and needs to be entered into the system, or that a particular asset has been replaced or otherwise modified, or that a particular asset has changing tracking/maintenance needs.

From the foregoing detailed description, it should be apparent that a method and system for providing proactive tracking and maintenance of assets/equipment required for a given industrial application, such as, for example, a drilling rig, has been disclosed. Although a specific embodiment of the invention has been described herein, it is to be understood that this has been done solely for the purposes of illustrating various features and aspects of the invention, and is not intended to be limiting with respect to the scope of the invention, as defined in the claims. It is contemplated and to be understood that various substitutions, alterations, and/or modifications, including such implementation variants and options as may have been specifically noted or suggested herein, may be made to the disclosed embodiment of the invention without departing from the spirit or scope of the invention.

What is claimed is:

1. An asset tracking and maintenance scheduling and verification system for a collection of assets, comprising:
for each asset in said collection of assets, an identifier sufficient to distinguish each asset from all others;
a system server adapted to generate at least one task list for said collection of assets;
a remote device selectively coupled to said system server for receiving said at least one task list from said system server;
said remote device having a user interface for directing a user to conduct a sequence of tasks specified in said at least one task list;
wherein each task in said sequence of task requires:
(i) interrogating a specified asset to obtain said asset's identifier; and
(ii) performing an action involving said specified asset;
(iii) communicating data reflecting performance of said action to said system server;
and wherein said system server is responsive to communication of said data reflecting performance of an action to update a database including at least one record corresponding to each one of said collection of assets.

2. A system in accordance with claim 1, wherein said system server communicates with said remote device via a wireless communications link.

3. A system in accordance with claim 1, wherein said identifier comprises a radio-frequency identification tag.

4. A system in accordance with claim 1, wherein said system server generates a task list based upon updated information in said database.

5. A method of asset tracking and maintenance scheduling and verification for a collection of assets, comprising:
for each asset in said collection of assets, providing an identifier having information sufficient to distinguish each said asset from all others;
implementing a system server adapted to generate at least one task list for said collection of assets;
providing a remote device adapted to be selectively coupled to said system server for receiving said at least one task list from said system server;
said remote device having a user interface for directing a user to conduct a sequence of tasks specified in said at least one task list;
wherein each task in said sequence of task requires:
(i) interrogating a specified asset to obtain said asset's identifier;
(ii) performing an action involving said specified asset; and
(iii) communicating data reflecting performance of said action to said system server;
and wherein said system server is responsive to communication of said data reflecting performance of an action to update a database including at least one record corresponding to each one of said collection of assets.

6. A method in accordance with claim 5, wherein said system server communicates with said remote device via a wireless connection.

7. A method in accordance with claim 5, wherein said identifier comprises a radio-frequency identification tag.

8. A method in accordance with claim 5, further comprising generating a task list based upon updated information in said database.

9. A machine-readable data storage medium tangibly embodying a set of instructions for controlling a computer system including a central server and a remote unit to perform the method of any of claims 5 through 8.
